(19) United States
(12) Patent Application Publication
(10) Pub. No.: US 2009/0190041 A1
(43) Pub. Date: Jul. 30, 2009

(54) Television Receiver

(75) Inventor: Shusuke NARITA, Daito-shi (JP)

Correspondence Address: CROWELL & MORING LLP;INTELLECTUAL PROPERTY GROUP, P.O. BOX 14300, WASHINGTON, DC, 20044-4300, US

(73) Assignee: Funai Electric Co., Ltd., Daito-shi (JP)

(21) Appl. No.: 12/359,629

(22) Filed: Jan. 26, 2009

(30) Foreign Application Priority Data
Jan. 25, 2008 (JP) 2008-015536

(51) Int. Cl. H04N 5/63

(52) U.S. Cl. 348/730; 348/E05.096

(57) ABSTRACT

A digital/analog receiver for use with a smart antenna connected thereto. The digital/analog receiver determines whether it is unnecessary to use the smart antenna for signal reception of a channel, i.e., video images based on television signals on the channel can be normally displayed without using the smart antenna, or it is necessary to use the smart antenna for signal reception of the channel, i.e., video images based on television signals on the channel cannot be normally displayed without using the smart antenna. Based on the result, if the digital/analog receiver determines that it is unnecessary to use the smart antenna, it does not supply power to the smart antenna when the channel is selected. Otherwise, if the digital/analog receiver determines that it is necessary to use the smart antenna, it supplies power to the smart antenna when the channel is selected.

### BACKGROUND OF THE INVENTION

1. Field of the Invention

The present invention relates to a television receiver that receives television signals distributed from broadcast stations and displays video images based on the television signals.

2. Description of the Related Art

Television receivers are conventionally connected to an antenna via an electrical signal line for transmitting electrical signals generated with the reception of radio waves so that the television receivers can receive television signals, which are the electrical signals received from the electrical signal line, and display video images based on the television signals. Some of the television receivers are used with a smart antenna connected as the antenna.

Smart antenna is an antenna capable of switching the radio wave receiving direction to different directions. The smart antenna is connected to a television receiver via not only an electrical signal line but also a power supply line from which electric power is received and a control signal line from which a control signal for control of the radio wave receiving direction is received. In other words, the smart antenna is powered via the power supply line from the television receiver and receives a control signal for control of the radio wave receiving direction via the control signal line from the television receiver. When power is supplied to the smart antenna, the smart antenna outputs electrical signals generated with the reception of radio waves to the electrical signal line and further can change the radio wave receiving direction in response to a control signal. When no power is supplied to the smart antenna, the smart antenna does not output electrical signals generated with the reception of radio waves to the electrical signal line.

A television receiver used with a smart antenna connected thereto supplies power to the smart antenna and transmits a control signal to the smart antenna to control the smart antenna so that the radio wave receiving direction is switched to the best direction. Thus, with the smart antenna receiving radio waves in the best direction, the television receiver receives television signals, which are electrical signals received from the electrical signal line, and displays video images based on the television signals.

Japanese Laid-open Patent Publication No. HEI 7-254871 discloses a portable radio communication device that has multiple systems of receivers, and supplies power to a receiver in which a higher level of electric field is detected and does not supply power to the other receiver. Japanese Laid-open Patent Publication No. 2006-287722 discloses a diversity receiver that has the first antenna and receiving/demodulating portion and the second antenna and receiving/demodulating portion, and turns off the power supply to the second receiving/demodulating portion when the temporal change in reception environment is small. Japanese Laid-pen Patent Publication No. 2003-188751 discloses a receiver that turns off the power supply to an amplifier when the level of a received signal is equal to or higher than a predetermined threshold level. Japanese Laid-open Patent Publication No. 2000-341185 discloses a receiver that has multiple antennas and turns off the power supply to an antenna switching circuit when the field strength of received signals is high. Japanese Laid-open Patent Publication No. 2006-270736 discloses a television receiver that, for setting the receiving direction of a smart antenna, monitors the field strengths of received signals in a tuner circuit while switching the receiving direction of the smart antenna.

Meanwhile, in a place where the field strength of radio waves carrying television signals (radio waves in which television signals are superimposed on carrier waves of a given frequency) is high, e.g., in a place near the broadcast station, a television receiver may be able to receive television signals and normally display video images based on the television signals even without using an antenna. This is because, in a place where the field strength of radio waves is high, the role of antenna is fulfilled by an electrical signal line connected to the television receiver for connection to an antenna, electrical wiring to input electrical signals to a tuner (circuit that receives television signals or electrical signals received from the electrical signal line) in the television receiver, and the like.

However, the above described conventional television receivers to be used with a smart antenna connected thereto do not determine whether or not video images based on television signals can be displayed normally without using the smart antenna. Instead, the conventional television receivers supply power to the smart antenna to use the smart antenna regardless of whether or not video images based on television signals can be displayed normally without using the smart antenna. In other words, even under conditions where video images based on television signals can be normally displayed without using a smart antenna, the conventional television receivers supply power to the smart antenna to use the smart antenna and thus waste electricity. Even if the techniques disclosed in the above mentioned patent documents are applied, the above described problem cannot be solved.

### SUMMARY OF THE INVENTION

An object of the present invention is to provide a television receiver to be used with a smart antenna connected thereto that can reduce power consumption.

According to an aspect of the present invention, this object is achieved by a television receiver that receives television signals, which are electrical signals received from an electrical signal line, and displays video images based on the television signals, comprising: a smart antenna that is connected via the electrical signal line to the television receiver and that, when power is supplied to the smart antenna, can change a radio wave receiving direction and outputs an electrical signal generated with reception of a radio wave to the electrical signal line and, when no power is supplied to the smart antenna, does not output an electrical signal generated with reception of a radio wave to the electrical signal line; antenna power supply control means for controlling power supply to the smart antenna; antenna necessity determining means for determining whether it is unnecessary to use the smart antenna for reception of a channel, i.e., video images based on television signals on the channel can be normally displayed without using the smart antenna, or it is necessary to use the smart antenna for reception of the channel, i.e., video images based on television signals on the channel cannot be normally displayed without using the smart antenna; and television reception control means for controlling a television reception process that is a process for selecting a channel and displaying video images based on television signals on the selected channel.

In the television reception process by the television reception control means, the antenna power supply control means does not supply power to the smart antenna when a channel selected in the television reception process is a channel determined by the antenna necessity determining means not to require the use of the smart antenna; and the antenna power supply control means supplies power to the smart antenna when the channel selected in the television reception process is a channel determined by the antenna necessity determining means to require the use of the smart antenna.

In the television receiver configured as described above, when it is not necessary to use the smart antenna, i.e., when video images based on television signals can be normally displayed without using the smart antenna, no power is supplied to the smart antenna. Thereby, the television receiver can avoid unnecessary consumption of electricity and thus reduce power consumption.

Preferably, the television receiver further comprises antenna direction determining means for determining a best direction of the smart antenna for reception of a channel, wherein the antenna direction determining means determines the best direction for a channel determined by the antenna necessity determining means to require the use of the smart antenna. Thereby, for a channel determined not to require the use of the smart antenna, the television receiver can skip the process for determining the best receiving direction of the smart antenna. Accordingly, power consumption can be further reduced.

Preferably, the television receiver further comprises automatic scanning control means for controlling an automatic scanning process for automatically detecting selectable channels, wherein, during the automatic scanning process by the automatic scanning control means to determine whether or not each channel is selectable, the antenna necessity determining means determines whether or not it is necessary to use the smart antenna for reception of the each channel. Thereby, when the television receiver starts the television reception process (process for selecting a channel and displaying video images based on television signals on the channel), the television receiver can quickly and normally display video images based on television signals without performing the process for determining whether or not the reception requires the use of the smart antenna.

Preferably, during the television reception process by the television reception control means, the antenna necessity determining means determines whether or not it is necessary to use the smart antenna for reception of a channel selected in the television reception process. Thereby, if the condition has changed during the television reception process and it becomes necessary to use the smart antenna for the reception, the television receiver can start to supply power to the smart antenna so as to continue to normally display video images based on television signals by using the smart antenna.

While the novel features of the present invention are set forth in the appended claims, the present invention will be better understood from the following detailed description taken in conjunction with the drawings.

### BRIEF DESCRIPTION OF THE DRAWINGS

The present invention will be described hereinafter with reference to the annexed drawings. It is to be noted that all the drawings are shown for the purpose of illustrating the technical concept of the present invention or embodiments thereof, wherein:

FIG. 1 is an electrical block diagram schematically showing the configuration of a digital/analog receiver according to one embodiment of the present invention;

FIG. 2 illustrates a channel reception table in the digital/analog receiver;

FIG. 3 is a flowchart showing an automatic scanning process in the digital/analog receiver;

FIG. 4 is a flowchart showing a smart antenna signal search process in the digital/analog receiver;

FIG. 5 is a flowchart showing a television reception process in the digital/analog receiver;

FIG. 6 is a flowchart showing a channel selection process in the digital/analog receiver; and

FIG. 7 is a flowchart showing a channel selection recovery process in the digital/analog receiver.

### DESCRIPTION OF THE PREFERRED EMBODIMENTS

Referring now to the accompanying drawings, a television receiver embodying the present invention is described. It is to be noted that the following description of preferred embodiment of the present invention has been presented for purposes of illustration and description, and is not intended to be exhaustive or to limit the present invention to the precise form disclosed.

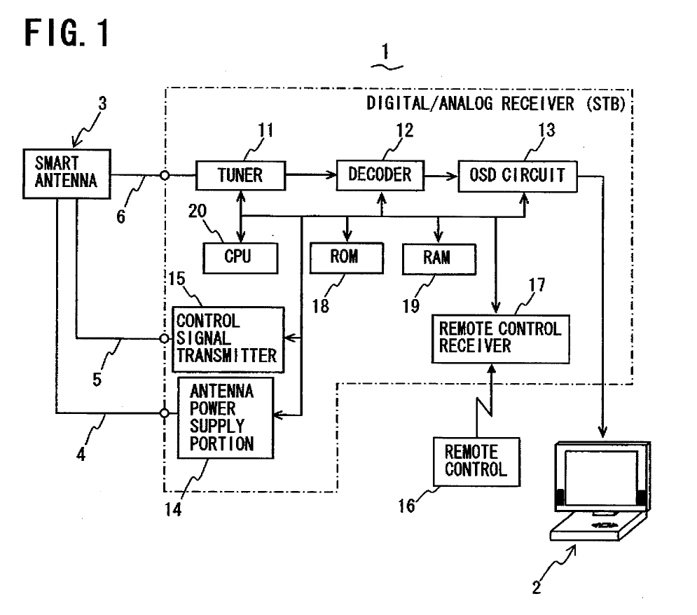

FIG. 1 shows the configuration of a digital/analog receiver (STB) 1 that is a television receiver according to this embodiment. The digital/analog receiver 1 is a device that receives television signals distributed in the form of radio waves (by superimposing the signals on carrier waves of a given frequency) from a broadcast station, and displays video images based on the television signals.

The digital/analog receiver 1 is used with a display 2 connected thereto so as to display video images based on television signals on the connected display 2. Further, the digital/analog receiver 1 can be connected to a smart antenna 3 as an antenna for receiving television signals so as to receive television signals via the smart antenna 3.

The smart antenna 3 is an antenna in conformity with the Electronic Industries Association (EIA)-909 standard, and is designed to switch its radio wave receiving direction to any one of sixteen directions. The smart antenna 3 is connected to a power supply line 4 through which electric power is supplied, a control signal line 5 through which control signals for control of the radio wave receiving direction are supplied, and an electrical signal line 6 through which electrical signals generated with the reception of radio waves are transmitted. In other words, the smart antenna 3 is powered from the power supply line 4, receives control signals for control of the radio wave receiving direction from the control signal line 5, and outputs electrical signals generated with the reception of radio waves to the electrical signal line 6.

The smart antenna 3 comprises an array of antenna elements capable of receiving radio waves in different directions, an antenna controller that controls the operation of the smart antenna 3, and so on. The antenna controller is supplied power from the power supply line 4 so as to operate. When power is supplied to the antenna controller, the antenna controller connects the array of antenna elements with the electrical signal line 6 and switches the direction for reception of radio waves by the antenna element array to one of the sixteen directions in response to a control signal from the control signal line 5. When no power is supplied to the antenna controller, the antenna controller breaks the connection between the antenna element array and the electrical signal line 6.

Thus, when power is supplied to the smart antenna 3 from the power supply line 4, the smart antenna 3 can change the radio wave receiving direction in accordance with a control signal received from the control signal line 5 and outputs electrical signals generated with the reception of radio waves to the electrical signal line 6. On the other hand, when no power is supplied from the power supply line 4 to the smart antenna 3, the smart antenna 3 does not output electrical signals generated with the reception of radio waves to the electrical signal line 6.

The smart antenna 3 configured as described above is connected to the digital/analog receiver 1 via the power supply line 4 through which electric power is supplied, the control signal line 5 through which control signals for control of the radio wave receiving direction is supplied, and the electrical signal line 6 through which electrical signals generated with the reception of radio waves are transmitted. In other words, the smart antenna 3 is supplied power from the digital/analog receiver 1 via the power supply line 4, receives control signals for control of the radio wave receiving direction from the digital/analog receiver 1 via the control signal line 5, and provides electrical signals generated with the reception of radio waves to the digital/analog receiver 1 via the electrical signal line 6.

The digital/analog receiver 1 supplies power to the smart antenna 3 via the power supply line 4 and transmits control signals for control of the radio wave receiving direction to the smart antenna 3 via the control signal line 5 so as to switch the radio wave receiving direction of the smart antenna 3 to one of the sixteen directions. Further, the digital/analog receiver 1 receives via the electrical signal line 6 electrical signals generated with the reception of radio waves by the smart antenna 3.

By supplying power to the smart antenna 3 via the power supply line 4 from the digital/analog receiver 1, electrical signals generated with the reception of radio waves by the smart antenna 3 are provided to the digital/analog receiver 1 via the electrical signal line 6. Further, by transmitting a control signal from the digital/analog receiver 1 via the control signal line 5 to the smart antenna 3, the radio wave receiving direction of the smart antenna 3 is controlled.

The digital/analog receiver 1 comprises a tuner 11, a decoder 12, an on-screen display (OSD) circuit 13, an antenna power supply portion 14, a control signal transmitter 15, a remote control 16, a remote control receiver 17, a ROM 18, a RAM 19, a CPU 20 that controls the operation of the digital/analog receiver 1, and so on.

The tuner 11 receives television signals on a channel via the electrical signal line 6 when the reception frequency is set to a frequency corresponding to the channel for the television signals under the control of the CPU 20. Then, the tuner 11 demodulates the received television signals, produces a transport stream (TS) (a sort of packet data digitally compressed and multiplexed) containing signals relating to video images based on the television signals (signals such as brightness signals, color signals, and synchronization signals), channel information for electronic program guide (information such as the title, content, and broadcast date and time of a program), and so on, and provides the TS to the decoder 12. Further, the tuner 11 calculates an error rate in demodulating television signals to produce the TS, and provides the error rate information to the CPU 20.

Under the control of the CPU 20, the decoder 12 analyzes the TS produced by the tuner 11 to decode the signals relating to video images based on television signals, the channel information for electronic program guide, and so on from the TS. Then, the decoder 12 processes the signals relating to video images decoded from the TS, produces video signals in a form that allows the video images based on television signals to be displayed on the display 2, and provides the video signals to the OSD circuit 13. Further, the decoder 12 provides the channel information decoded from the TS to the CPU 20.

Under the control of the CPU 20, the OSD circuit 13 processes the video signals produced by the decoder 12 so that the video images based on television signals and on-screen images, which show information on a command from the remote control 16, information on various settings, and so on, can be displayed selectively or together on the display 2. The signals processed by the OSD circuit 13 are output to the display 2 under the control of the CPU 20. Then, the video images based on television signals and the on-screen images are displayed selectively or together on the display 2.

Under the control of the CPU 20, the antenna power supply portion 14 supplies power for driving the smart antenna 3 via the power supply line 4 to the smart antenna 3. More particularly, the antenna power supply portion 14 starts to supply power to the smart antenna 3 via the power supply line 4 in response to a power-on command from the CPU 20, and stops supplying power to the smart antenna 3 in response to a power-off command from the CPU 20.

Under the control of the CPU 20, the control signal transmitter 15 transmits a control signal for control of the radio wave receiving direction of the smart antenna 3 via the control signal line 5 to the smart antenna 3. The control signal for control of the radio wave receiving direction of the smart antenna 3 includes a signal indicating a direction for reception of radio waves, a signal representing a command to switch the radio wave receiving direction, and so on.

The remote control 16 is operated by a user to send various commands to the digital/analog receiver 1 such as a command to turn on or off the digital/analog receiver 1 and a command to select a television channel. The remote control 16 has various operation keys that are operated by a user to send various commands to the digital/analog receiver 1. When the operation keys are operated, the remote control 16 sends infrared signals corresponding to the operation. The remote control receiver 17 receives the infrared signals sent from the remote control 16 and converts the infrared signals to electrical signals. Then, the remote control receiver 17 provides to the CPU 20 the received remote control signals corresponding to the user operation on the remote control 16.

The ROM 18 stores programs for controlling the operation of the digital/analog receiver 1 and various kinds of data (for example, frequency data indicating the reception frequency of each television channel). The ROM 18 is writable (rewritable) and stores a channel reception table indicating the optimum use of the smart antenna 3 for each television channel under the control of the CPU 20. The RAM 19 temporarily stores various kinds of data relating to the operation of the digital/analog receiver 1 under the control of the CPU 20.

When the remote control 16 is operated, the CPU 20 controls various operations of the digital/analog receiver 1 based on programs and various kinds of data stored in the ROM 18 and various kinds of data temporarily stored in the RAM 19. Antenna power supply control means, automatic scanning control means, television reception control means, antenna necessity determining means, and antenna direction determining means in claims include the CPU 20 and the programs and various kinds of data stored in the ROM 18.

The CPU 20 controls the power supply to the smart antenna 3. For controlling the power supply to the smart antenna 3, the CPU 20 issues a power-on command and a power-off command to the antenna power supply portion 14. When the CPU 20 issues a power-on command to the antenna power supply portion 14, the antenna power supply portion 14 supplies power to the smart antenna 3 via the power supply line 4. When the CPU 20 issues a power-off command to the antenna power supply portion 14, the antenna power supply portion 14 stops supplying power to the smart antenna 3.

The CPU 20 controls the radio wave receiving direction of the smart antenna 3. For controlling the radio wave receiving direction of the smart antenna 3, the CPU 20 issues a command to transmit a control signal to the control signal transmitter 15. When the CPU 20 issues the control signal transmit command to the control signal transmitter 15, the control signal transmitter 15 transmits a control signal to the smart antenna 3 via the control signal line 5. In response to the control signal, the smart antenna 3 controls the radio wave receiving direction.

The CPU 20 controls an automatic scanning process that is a process for automatically detecting selectable channels, a television reception process that is a process for selecting a television channel and displaying video images based on television signals on the selected channel, and so on.

For each television channel, the CPU 20 determines whether or not it is necessary to use an antenna for reception of the channel, i.e., whether or not video images based on television signals on the channel can be normally displayed without using the smart antenna 3 (in other words, without supplying power to the smart antenna 3). For determining whether or not it is necessary to use the smart antenna 3 for the reception, the CPU 20 attempts to receive television signals by the tuner 11 without supplying power to the smart antenna 3, and attempts to analyze by the decoder 12 a TS (signals digitally compressed and multiplexed that are produced by the tuner demodulating television signals and contain signals relating to video images based on the television signals, channel information for electronic program guide, and so on). If the error rate (error rate in demodulating the television signals to produce the TS) received from the tuner 11 is less than a threshold and if the TS has been successfully analyzed by the decoder 12 (i.e., if channel information has been obtained from the decoder 12), the CPU 20 determines that it is not necessary to use an antenna.

For a channel determined to require the use of an antenna, the CPU 20 determines the best antenna direction, i.e., the direction for optimal reception of radio waves by the smart antenna 3. For determining the best antenna direction, the CPU 20 supplies power to the smart antenna 3 and attempts to receive television signals by the tuner 11 and analyze the TS by the decoder 12 while switching the radio wave receiving direction of the smart antenna 3 to each of a plurality of directions. Determined by the CPU 20 to be the best antenna direction is the radio wave receiving direction of the smart antenna 3 when the error rate received from the tuner 11 is the lowest and less than the threshold and the TS has been successfully analyzed by the decoder 12.

The CPU 20 reflects the determination of whether or not it is necessary to use an antenna and the determination of the best antenna direction to the use of the smart antenna 3 in the television reception process. More particularly, in the television reception process, the CPU 20 does not supply power to the smart antenna 3 if the channel selected in the television reception process is a channel determined not to require the use of an antenna. Otherwise, if the channel selected in the television reception process is a channel determined to require the use of an antenna, the CPU 20 supplies power to the smart antenna 3 and sets the radio wave receiving direction of the smart antenna 3 to the best antenna direction.

The CPU 20 stores the result of the determination of whether or not it is necessary to use an antenna and the result of the determination of the best antenna direction in the channel reception table stored in the ROM 18. In the television reception process, the CPU 20 controls the power supply to the smart antenna 3 and the radio wave receiving direction of the smart antenna 3 based on the determination results stored in the channel reception table. Thereby, the CPU 20 reflects the determination of whether or not it is necessary to use an antenna and the determination of the best antenna direction to the use of the smart antenna 3 in the television reception process.

During the automatic scanning process to determine whether or not respective channels are selectable, the determination of the necessity for use of an antenna and the determination of the best antenna direction are made for the respective channels. Further, during the television reception process, the determinations are also made for the channel selected in the television reception process.

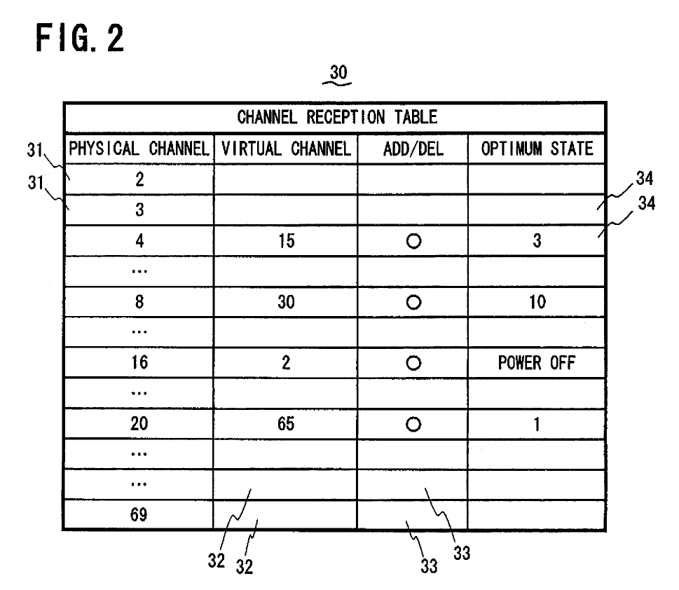

FIG. 2 shows the channel reception table stored in the ROM 18. The channel reception table 30 has a plurality of physical channel areas 31, a plurality of virtual channel areas 32, a plurality of ADD/DEL areas 33, and a plurality of optimum state areas 34.

The physical channel areas 31 are storage areas that store physical channel numbers for identification of television channels. The virtual channel areas 32 are storage areas provided for the respective television channels to store virtual channel numbers (channel numbers to be recognized and used by a user) virtually associated with the respective channels. The ADD/DEL areas 33 are storage areas provided for the respective television channels to store information indicating that the corresponding channel is a selectable channel. The optimum state areas 34 are storage areas provided for the respective television channels to store information on the optimum use of the smart antenna 3 for the respective channels.

In the example shown in FIG. 2, the numbers “2”, “3”, “4” . . . “8” . . . “16” . . . “20” . . . “69” in the physical channel areas 31 indicate the physical channel numbers. The numbers “15”, “30”, “2”, and “65” in the virtual channel areas 32 indicate the virtual channel numbers. The marks “∘” in the ADD/DEL areas 33 indicate that the channels can be selected. The numbers “3”, “10”, and “1” in the optimum state areas 34 indicate that the smart antenna 3 can be used optimally when the radio wave receiving direction of the smart antenna 3 is set to the directions indicated by the numbers. More particularly, the numbers in the areas 34 indicate the best antenna directions. The words “POWER OFF” in the optimum state area 34 indicate that power should not be supplied to the smart antenna 3 in order to optimally use the smart antenna 3.

More particularly, the following information regarding television signals on the respective physical channels are stored in the channel reception table 30 shown in FIG. 2. Regarding television signals on the physical channel number ““4”, the virtual channel number is “15”, the channel is selectable, and the smart antenna 3 can be used optimally when the radio wave receiving direction is set to the third direction. Regarding television signals on the physical channel number “8”, the virtual channel number is “30”, the channel is selectable, and the smart antenna 3 can be used optimally when the radio wave receiving direction is set to the tenth direction. Regarding television signals on the physical channel number “16”, the virtual channel number is “2”, the channel is selectable, and power should not be supplied to the smart antenna 3 in order to optimally use the smart antenna 3 (that is, the smart antenna 3 should not be used). Regarding television signals on the physical channel number “20”, the virtual channel number is “65”, the channel is selectable, and the smart antenna 3 can be used optimally when the radio wave receiving direction is set to the first direction.

In the initial state of the digital/analog receiver 1, e.g., before shipping, stored in the channel reception table 30 are the physical channel numbers in the physical channel areas 31 and the virtual channel numbers in the virtual channel areas 32. Information regarding whether the respective channels are selectable and information on the optimum use of the smart antenna 3 are not stored in the ADD/DEL areas 33 and the optimum state areas 34 in the initial state. After the determination of whether or not it is necessary to use an antenna for signal reception and the determination of the best antenna direction are made as described above, information indicating that the channel is selectable and information on the optimum use of the smart antenna 3 are stored in the ADD/DEL areas 33 and the optimum state areas 34, respectively.

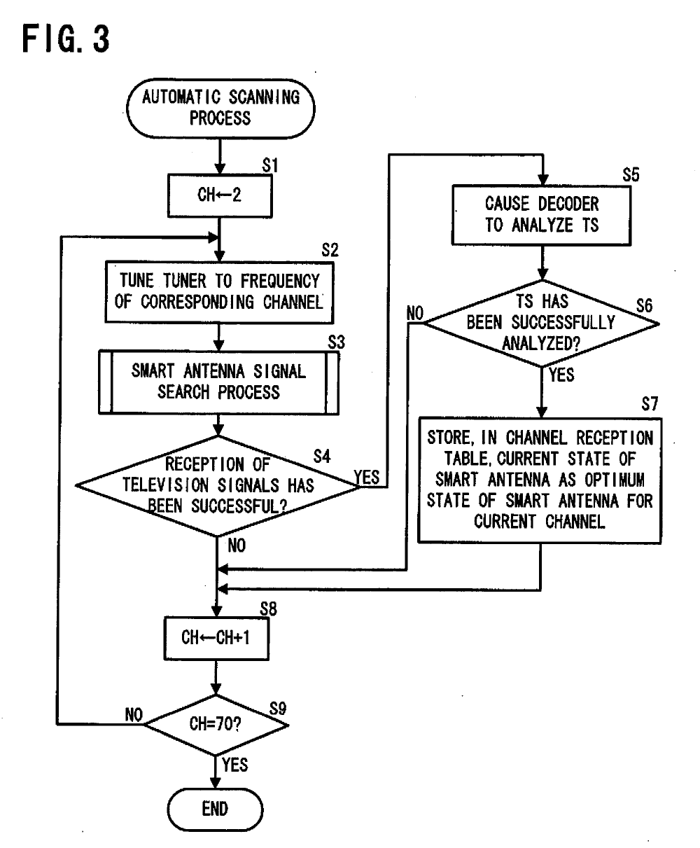

FIG. 3 is a flowchart showing the automatic scanning process of the digital/analog receiver 1. The automatic scanning process is performed when a user enters a command to perform the automatic scanning process. In the automatic scanning process, the CPU 20 first sets the value of a variable CH representing the physical channel number to “2” (S1).

Then, the CPU 20 tunes the tuner 11 to the frequency of the channel corresponding to the physical channel number represented by the value of the variable CH (S2), and performs a smart antenna signal search process (S3).

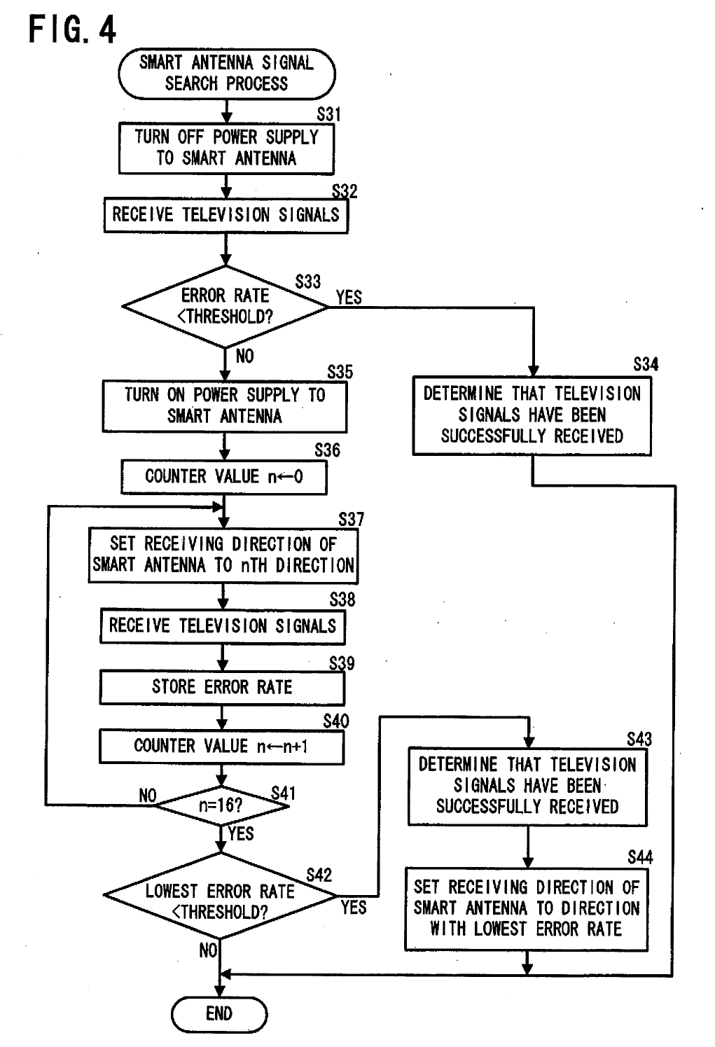

FIG. 4 is a flowchart showing the smart antenna signal search process. In the smart antenna signal search process, the CPU 20 first turns off the power supply to the smart antenna 3 (S31), causes the tuner 11 to receive television signals (S32), and determines whether or not an error rate received from the tuner 11 at the time is less than the threshold (S33).

If the error rate is less than the threshold (YES at S33), the CPU 20 determines that the television signals have been successfully received (S34), and exits the smart antenna signal search process.

On the other hand, if the error rate is not less than the threshold (NO at S33), the CPU 20 turns on the power supply to the smart antenna 3 (S35), and sets a counter value n, which corresponds to the radio wave receiving direction of the smart antenna 3 (sixteen directions of zeroth to fifteenth directions), to “0” (S36).

Subsequently, the CPU 20 sets the receiving direction of the smart antenna 3 to the nth direction (S37), causes the tuner 11 to receive television signals (S38), and stores an error rate (Rₙ) received from the tuner 11 at the time (S39). Further, the CPU 20 increments the counter value n by one (S40).

At this time, if the counter value n is not “16” (NO at S41), the CPU 20 repeats the steps S37 to S41. Accordingly, the same process is performed for the next receiving direction of the smart antenna 3 to store an error rate when the receiving direction of the smart antenna 3 is set to the next direction.

When the counter value n reaches “16” (YES at S41), it means that error rates (R₀, R₁, R₂ . . . , and R₁₅) have been stored for all of the sixteen directions (zeroth to fifteenth directions) of the smart antenna 3. The CPU 20 then determines whether or not the lowest of the error rates R₀ to R₁₅ is less than the threshold (S42).

If the lowest error rate is less than the threshold (YES at S42), the CPU 20 determines that the television signals have been successfully received (S43), sets the receiving direction of the smart antenna 3 to the direction with the lowest error rate (S44), and exits the smart antenna signal search process. Otherwise, if the lowest error rate is not less than the threshold (NO at S42), the CPU 20 exits the smart antenna signal search process without determining that the television signals have been successfully received.

Returning to FIG. 3, when the reception of television signals has been successful (YES at S4) as a result of the smart antenna signal search process, the CPU 20 causes the decoder 12 to analyze the TS (S5), and determines whether or not the TS has been successfully analyzed (S6). At this step, the CPU 20 determines that the TS has been successfully analyzed when the CPU 20 has successfully received channel information from the decoder 12, and determines that the TS has not been successfully analyzed when the CPU 20 has failed to receive channel information from the decoder 12.

If the TS has been successfully analyzed (YES at S6), the CPU 20 determines that video images based on television signals can be normally displayed, and stores, in the channel reception table 30, the current state (power-off state or receiving direction) of the smart antenna 3 as the optimum state of the smart antenna 3 for the channel (S7).

More particularly, when the result at the step S33 is YES and thus the step S34 is performed in the smart antenna signal search process at the above step S3 (process shown in FIG. 4), the CPU 20 stores data indicating power-off in the optimum state area 34 for the current channel in the channel reception table 30. On the other hand, when the result at the step S33 is NO and thus the steps from the step S35 are performed, the CPU 20 stores data indicating the current receiving direction (receiving direction set at the above step S44 in the smart antenna signal search process shown in FIG. 4) as the best antenna direction in the optimum state area 34 for the current channel in the channel reception table 30.

Further, at this time, the CPU 20 determines that the current channel is a selectable channel, and stores data indicating that the current channel is a selectable channel in the ADD/DEL area 33 for the current channel in the channel reception table 30.

More particularly, in this automatic scanning process, when the results at the steps S4 and S6 are YES after the smart antenna signal search process at the step S3, the channel at the time is determined to be a selectable channel. At this time (when the channel at the time is determined to be a selectable channel), if the result at the step S33 is YES and the step S34 has been performed in the smart antenna signal search process at the step S3, it is determined that it is not necessary to use an antenna for reception of the channel, i.e., that video images based on television signals can be normally displayed without using the smart antenna 3. On the other hand, if the result at the step S33 is NO and the steps from the step S35 have been performed (thus, if it is determined that it is necessary to use an antenna for reception of the channel), the receiving direction set at the step S44 is determined to be the best antenna direction. Then, the result of the determination is stored in the channel reception table 30.

Following the step S7, the CPU 20 increments by one the value of the variable CH representing the physical channel number (S8). On the other hand, if the TS has not been successfully analyzed (NO at S6), the CPU 20 increments by one the value of the variable CH representing the physical channel number without performing the step S7 (S8). If the reception of television signals has not been successful as a result of the smart antenna signal search process (NO at S4), the CPU 20 increments by one the value of the variable CH representing the physical channel number without performing the steps 5 to 7 (S8).

Then, if the value of the variable CH is not “70” (NO at S9), the CPU 20 repeats the steps from the above step S2. Thereby, the same process is performed for the next channel. When the value of the variable CH reaches “70” (YES at S9), it means that the same process has been completed for all the channels. Thus, the CPU 20 exits the automatic scanning process.

In the automatic scanning process, a selectable channel is detected in the manner described above. During the process to determine whether or not a channel is selectable, whether or not it is necessary to use an antenna for reception of the channel is determined. Further, for a channel determined to require the use of an antenna, the best antenna direction is determined.

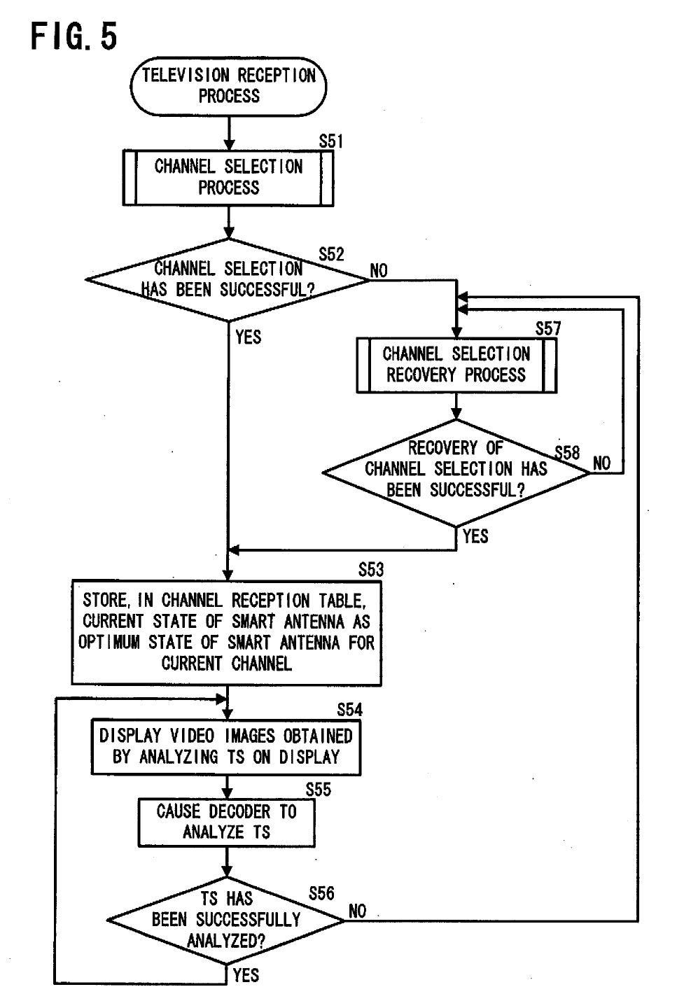

FIG. 5 is a flowchart showing the television reception process of the digital/analog receiver 1. The television reception process is started (1) automatically at the end of the automatic scanning process, (2) in response to a user command to perform the television reception process, and (3) automatically when the digital/analog receiver 1 is turned on. In the television reception process, the CPU 20 first performs a channel selection process to select a television channel (S5 1).

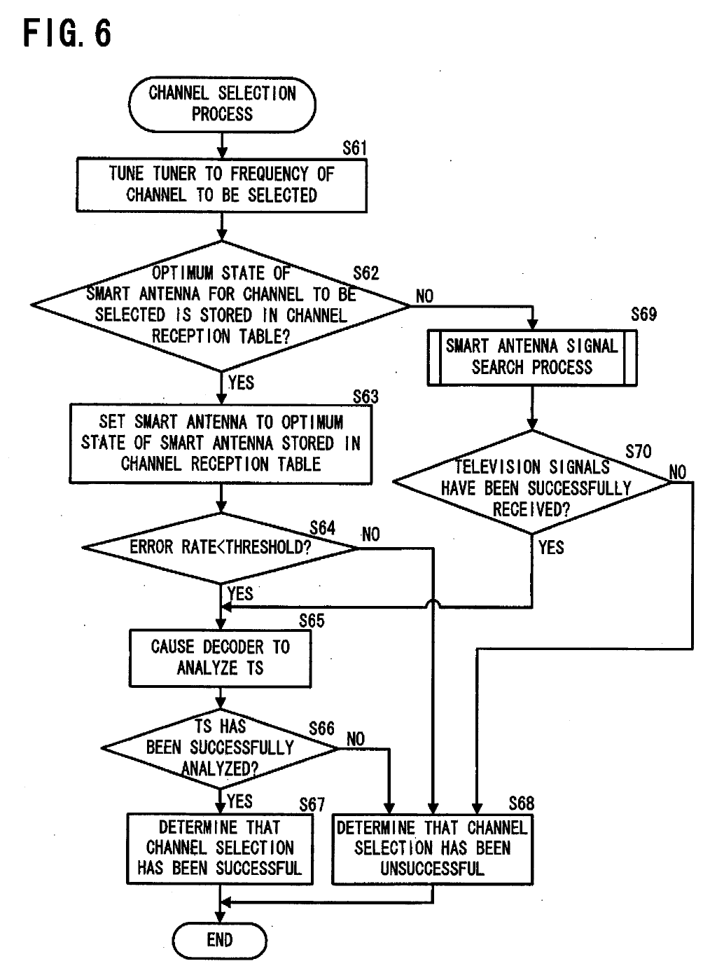

FIG. 6 is a flowchart showing the channel selection process. In the channel selection process, the CPU 20 first tunes the tuner 11 to the frequency of a channel to be selected (S61). If the current television reception process is one automatically started at the end of the automatic scanning process, the channel to be selected is a channel having the smallest virtual channel number. If the current television reception process is one started in response to a command from a user, the channel to be selected is a channel having a virtual channel number selected by the user entering the command. If the current television reception process is one automatically started when the digital/analog receiver 1 is turned on, the channel to be selected is a channel last selected in the last use of the digital/analog receiver 1.

Subsequently, the CPU 20 determines whether or not information on the optimum state of the smart antenna 3 for the channel to be selected is stored in the channel reception table 30 (S62). More particularly, the CPU 20 determines whether or not data indicating that the channel is selectable is stored in the ADD/DEL area 33 for the channel to be selected in the channel reception table 30 and whether or not data indicating power-off or data indicating the receiving direction (best antenna direction) is stored in the optimum state area 34 for the channel to be selected in the channel reception table 30.

If the optimum state of the smart antenna 3 for the channel to be selected is stored in the channel reception table 30 (YES at S62), the CPU 20 sets the smart antenna 3 to the optimum state of the smart antenna 3 that is stored in the channel reception table 30 (S63). More particularly, if data indicating power-off is stored in the optimum state area 34 for the channel to be selected in the channel reception table 30, the CPU 20 turns off the power supply to the smart antenna 3. If data indicating the receiving direction is stored in the area, the CPU 20 sets the receiving direction of the smart antenna 3 to the direction indicated by the data (best antenna direction).

Subsequently, the CPU 20 determines whether or not an error rate received from the tuner 11 at the time is less than the threshold (S64).

If the error rate is less than the threshold (YES at S64), the CPU 20 causes the decoder 12 to analyze the TS (S65), and determines whether or not the TS has been successfully analyzed (S66).

If the TS has been successfully analyzed (YES at S66), the CPU 20 determines that the channel selection has been successful (S67), and exits the channel selection process. On the other hand, if the error rate is not less than the threshold (NO at S64) or if the TS has not been successfully analyzed (NO at S66), the CPU 20 determines that the channel selection has been unsuccessful (S68), and exits the channel selection process.

If the optimum state of the smart antenna 3 for the channel to be selected is not stored in the channel reception table 30 (NO at S62), the CPU 20 performs the smart antenna signal search process (the process as shown in FIG. 4) (S69). Then, if television signals have been successfully received as a result of the smart antenna signal search process (YES at S70), the CPU 20 performs the above steps S65 and S66, and determines that the channel selection has been successful (S67) or determines that the channel selection has been unsuccessful (S68), and exits the channel selection process. On the other hand, if television signals have not been successfully received (NO at S70), the CPU 20 determines that the channel selection has been unsuccessful (S68), and exits the channel selection process.

Returning to FIG. 5, if the channel selection has been successful as a result of the channel selection process (YES at S52), the CPU 20 determines that video images based on television signals can be normally displayed, and stores in the channel reception table 30 the current state (power-off state or receiving direction) of the smart antenna 3 as the optimum state of the smart antenna 3 for the channel (that is, updates the channel reception table 30) (S53).

Subsequently, the CPU 20 displays video images obtained by analyzing the TS (i.e., video images based on television signals) on the display 2 (S54). After that, the CPU 20 causes the decoder 12 to analyze TSs produced sequentially by the tuner 11 (S55), and repeats the steps S54 to S56 as long as the analysis of TSs is successful (YES at S56). Thereby, video images based on television signals are continuously displayed.

If a TS has not been successfully analyzed (NO at S56) or if the channel selection has been unsuccessful as a result of the channel selection process (NO at S52), the CPU 20 performs a channel selection recovery process (S57).

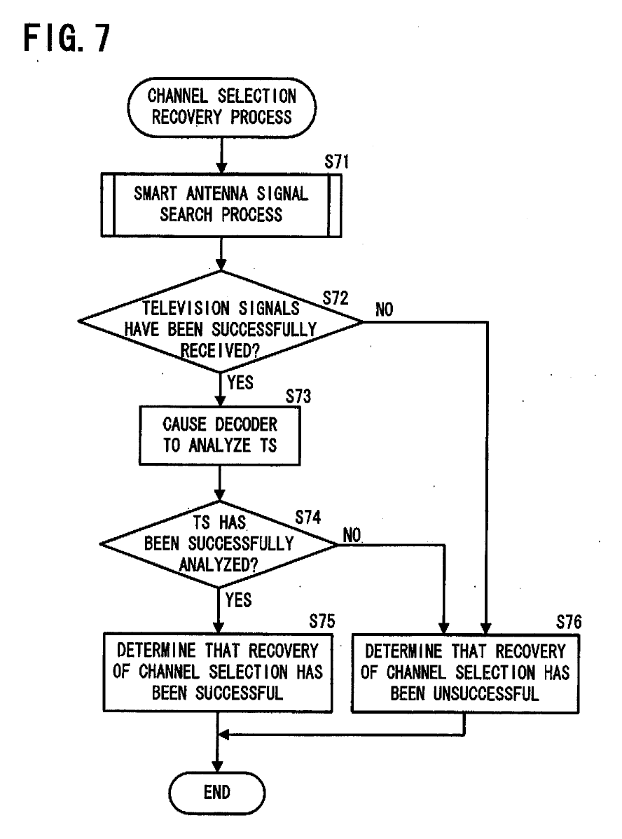

FIG. 7 is a flowchart showing the channel selection recovery process. In the channel selection recovery process, the CPU 20 first performs the smart antenna signal search process (the process as shown in FIG. 4) (S71). If television signals have been successfully received as a result of the smart antenna signal search process (YES at S72), the CPU 20 causes the decoder 12 to analyze the TS (S73), and determines whether or not the TS has been successfully analyzed (S74).

If the TS has been successfully analyzed (YES at S74), the CPU 20 determines that the recovery of the channel selection has been successful (S75), and exits the channel selection recovery process. On the other hand, if the TS has not been successfully analyzed (NO at S74) or if television signals have not been successfully received as a result of the smart antenna signal search process (NO at S72), the CPU 20 determines that the recovery of the channel selection has been unsuccessful (S76), and exits the channel selection recovery process.

Returning to FIG. 5, if the recovery of the channel selection has been unsuccessful as a result of the channel selection recovery process (NO at S58), the CPU 20 repeats the above step S57 (channel selection recovery process). Then, if the recovery of the channel selection has been successful (YES at S58), the CPU 20 determines that video images based on television signals can be normally displayed, and repeats the steps from the step S53.

In the television reception process, video images based on television signals on a selected channel are displayed in the manner described above. For a currently selected channel, whether or not it is necessary to use an antenna for signal reception is determined. Further, for a channel determined to require the use of an antenna, the best antenna direction is determined. In accordance with the determination results, the television reception process is continued.

According to the digital/analog receiver 1 configured as described above, when it is not necessary to use an antenna, i.e., when video images based on television signals can be normally displayed without using the smart antenna 3, no power is supplied to the smart antenna 3. This can avoid unnecessary consumption of electricity and thus reduce power consumption.

Further, for only a channel determined to require the use of an antenna, the best antenna direction (the best receiving direction of the smart antenna 3) is determined. Thus, for a channel determined not to require the use of an antenna, the process for determining the best antenna direction can be skipped. Accordingly, unnecessary consumption of electricity can be avoided for reduction of power consumption.

Further, during the automatic scanning process to automatically determine whether or not channels are selectable, whether or not it is necessary to use an antenna for reception of each of the channels is also determined. Thereby, when the television reception process (process for selecting a channel and displaying video images based on television signals on the channel) is started, video images based on television signals can be quickly and normally displayed without performing the process for determining whether or not the reception requires the use of an antenna.

Moreover, during the television reception process, it is determined whether or not it is necessary to use an antenna for reception of the channel currently selected in the television reception process. Thereby, if the condition has changed during the television reception process and it becomes necessary to use an antenna for the reception, the digital/analog receiver 1 can start to supply power to the smart antenna 3 so as to continue to normally display video images based on television signals by using the smart antenna 3.

The present invention has been described above using a presently preferred embodiment, but those skilled in the art will appreciate that various modifications are possible. For example, it is also possible to determine whether or not it is necessary to use an antenna each time the television reception process is started. An antenna power supply portion that supplies power to the smart antenna can also be provided external to the digital/analog receiver in such a manner that the digital/analog receiver can control the power supply from the external antenna power supply portion to the smart antenna. Further, it is also possible to use a digital/analog receiver with a display.

This application is based on Japanese patent application 2008-015536 filed Jan. 25, 2008, the contents of which are hereby incorporated by reference.

What is claimed is:

1. A television receiver that receives television signals, which are electrical signals received from an electrical signal line, and displays video images based on the television signals, comprising:
a smart antenna that is connected via the electrical signal line to the television receiver and that, when power is supplied to the smart antenna, can change a radio wave receiving direction and outputs an electrical signal generated with reception of a radio wave to the electrical signal line and, when no power is supplied to the smart antenna, does not output an electrical signal generated with reception of a radio wave to the electrical signal line;
antenna power supply control means for controlling power supply to the smart antenna;
antenna necessity determining means for determining whether it is unnecessary to use the smart antenna for reception of a channel, i.e., video images based on television signals on the channel can be normally displayed without using the smart antenna, or it is necessary to use the smart antenna for reception of the channel, i.e., video images based on television signals on the channel cannot be normally displayed without using the smart antenna; and
television reception control means for controlling a television reception process that is a process for selecting a channel and displaying video images based on television signals on the selected channel,
wherein in the television reception process by the television reception control means,
the antenna power supply control means does not supply power to the smart antenna when a channel selected in the television reception process is a channel determined by the antenna necessity determining means not to require the use of the smart antenna; and
the antenna power supply control means supplies power to the smart antenna when the channel selected in the television reception process is a channel determined by the antenna necessity determining means to require the use of the smart antenna.

2. The television receiver according to claim 1, further comprising antenna direction determining means for determining a best direction of the smart antenna for reception of a channel,
wherein the antenna direction determining means determines the best direction for a channel determined by the antenna necessity determining means to require the use of the smart antenna.

3. The television receiver according to claim 2, further comprising automatic scanning control means for controlling an automatic scanning process for automatically detecting selectable channels,
wherein, during the automatic scanning process by the automatic scanning control means to determine whether or not each channel is selectable, the antenna necessity determining means determines whether or not it is necessary to use the smart antenna for reception of the each channel.

4. The television receiver according to claim 3,
wherein during the television reception process by the television reception control means, the antenna necessity determining means determines whether or not it is necessary to use the smart antenna for reception of a channel selected in the television reception process.

5. The television receiver according to claim 2,
wherein during the television reception process by the television reception control means, the antenna necessity determining means determines whether or not it is necessary to use the smart antenna for reception of a channel selected in the television reception process.

6. The television receiver according to claim 1, further comprising automatic scanning control means for controlling an automatic scanning process for automatically detecting selectable channels,
wherein, during the automatic scanning process by the automatic scanning control means to determine whether or not each channel is selectable, the antenna necessity determining means determines whether or not it is necessary to use the smart antenna for reception of the each channel.

7. The television receiver according to claim 1,
wherein during the television reception process by the television reception control means, the antenna necessity determining means determines whether or not it is necessary to use the smart antenna for reception of a channel selected in the television reception process.
